(19) United States
(12) Patent Application Publication
(10) Pub. No.: US 2016/0135475 A1
(43) Pub. Date: May 19, 2016

(54) OIL AND/OR FAT COMPOSITION FOR COOKING, METHOD FOR PRODUCING THE SAME, AND METHOD FOR REDUCING OIL AND/OR FAT CONTENT REMAINING IN COOKED MATERIAL AFTER COOKING

(71) Applicant: The Nisshin OilliO Group, Ltd., Tokyo (JP)

(72) Inventors: Yoshihiro MURANO, Kamakura-shi (JP); Reiko EJIRI, Yokohama-shi (JP); Takahide WATANABE, Tokyo (JP); Kanji AOYAGI, Tokyo (JP)

(73) Assignee: The Nisshin OilliO Group, Ltd., Tokyo (JP)

(21) Appl. No.: 14/934,709

(22) Filed: Nov. 6, 2015

(30) Foreign Application Priority Data
Nov. 14, 2014 (JP) 2014-231149

(51) Int. Cl. A23D 9/013

(52) U.S. Cl. CPC A23D 9/013

(57) ABSTRACT

Provided is an oil and/or fat composition for cooking comprising: an oil and/or fat; and 0.02 to 0.09% by mass of polyglycerin fatty acid esters, wherein the oil and/or fat in the oil and/or fat composition for cooking consists of one of or a combination of two or more of animal or vegetable oil and/or fats, hydrogenated oils and/or fats thereof, oil and/or fat fractions thereof, and transesterified oils and/or fats thereof, 80% by mass or more of glycerides of the oil and/or fat are triglycerides, the polyglycerin fatty acid esters have an HLB value of 3.5 or lower, and 5 to 50% by mass of constituent fatty acids of the polyglycerin fatty acid esters are an unsaturated fatty acid(s) having 8 to 22 carbon atoms. The composition is capable of efficiently reducing the oil content remaining in a cooked material. Defined methods producing and reducing are also provided.

### TECHNICAL FIELD

The present invention relates to an oil and/or fat composition for heat-cooking (hereinafter, referred to as “cooking”), a method for producing the oil and/or fat composition for cooking, and a method for reducing the oil and/or fat content remaining in a cooked material after cooking.

### BACKGROUND ART

As consumers have become more health-conscious recently, reduction of the amount of oil and/or fat in foods has been considered as a challenge. For example, Patent Literature 1 discloses a oil and/or fat composition used for stir frying, which is capable of reducing the amount of oil and/or fat absorbed by a cooked material during stir frying and which tastes good. In the case of this oil and/or fat composition, the amount of oil and/or fat absorbed by the cooked material is reduced by adding an emulsifier.

However, for preparing deep-fried foods such as FURAI (Japanese deep-fried foods coated with bread crumbs, in general), TEMPURA (Japanese deep-fried foods generally coated with batter of flour), and KARAAGE (Japanese deep-fried foods generally coated with (potato) starch or wheat flour, cooking in oil and/or fat is carried out. Hence, the replacement of water in a cooked material with oil and/or fat occurs more readily in deep-frying than in stir frying. Even when the fat composition described in Patent Literature 1 is used for deep-frying, it is difficult to obtain the same effect as in stir frying. Especially, the coating portion (the batter) of a deep-fried product has a high water content and hence has a property of easily absorbing oil and/or fat. In this respect, it is desirable that the amount of oil and/or fat absorbed by a deep-fried product should be reduced more efficiently, while the good taste of the deep-fried product is being retained. In theory, it can be expected that the increase in the amount of the emulsifier added will enhance the effect of reducing the amount of oil and/or fat absorbed. However, it is difficult to add the emulsifier in a large amount, because of problems such as increase in raw material costs and reduction of the original taste of oil and/or fat.

In addition, fats for deep-frying for professional use used in the cooking areas in supermarkets and in business categories such as foodservice are used under environments different from those of oils and/or fats for household use. Such an oil and/or fat for deep-frying for professional use is placed in a heated state for a long period, and many deep-frying ingredients are deep-fried in the oil and/or fat. For this reason, the load on the oil and/or fat is heavy. If a deep-frying oil and/or fat for household use itself is used for professional use, the degradation rate of the oil and/or fat is so high that the oil and/or fat has to be exchanged frequently. In this respect, a silicone oil is generally added at about several parts per million to oils and/or fats for deep-frying distributed and used for professional use. The silicone oil is known to form a coating film at the gas-liquid interface on the surface of heated oil and/or fat to reduce the contact of the oil and/or fat with oxygen as much as possible and also known to promote the collapse of bubbles formed in heated oil and/or fat to slow the degradation rate of the oil and/or fat.

Here, in a fat composition containing a silicone oil, the silicone oil forms a coating film at the gas-liquid interface. For this reason, it is not necessarily true that means for reducing the absorbed amount of oil and/or fat targeted at a fat composition for cooking not containing any silicone oil is effective for an oil and/or fat composition containing a silicone oil. In addition, it is conceivable that, when an emulsifier is added to an oil and/or fat composition containing a silicone oil, the silicone oil, which forms a coating film at the gas-liquid interface, may interact with the emulsifier, which exerts an influence on the tension at the gas-liquid or liquid-liquid interface to exert an adverse influence on the effect of the emulsifier which reduces the amount of oil and/or fat absorbed.

### [Patent Literature 1] JP 2005-218380A

### SUMMARY OF INVENTION

In this respect, an object of the present invention is to provide an oil and/or fat composition for cooking which is capable of efficiently reducing the oil and/or fat content remaining in a cooked material after cooking and which tastes good, a method for producing the oil and/or fat composition for cooking, and a method for reducing the oil and/or fat content remaining in a cooked material after cooking.

To achieve the above-described object, the present invention provides the following [1] to [8]:

[1] An oil and/or fat composition for cooking, comprising an oil and/or fat and 0.02 to 0.09% by mass of polyglycerin fatty acid esters,

wherein the fat in the oil and/or fat composition for cooking consists of one of or a combination of two or more of animal or vegetable oil and/or fats, hydrogenated oils and/or fats thereof, oil and/or fat fractions thereof, and transesterified oils and/or fats thereof,

80% by mass or more of glycerides of the oil and/or fat are triglycerides,

the polyglycerin fatty acid esters have an HLB value of 3.5 or lower, and

5 to 50% by mass of constituent fatty acids of the polyglycerin fatty acid esters are an unsaturated fatty acid(s) having 8 to 22 carbon atoms.

[2] The oil and/or fat composition for cooking of [1], wherein the content of the polyglycerin fatty acid esters is 0.04 to 0.08% by mass, and 0.5 to 5 ppm of a silicone oil is further contained.
[3] The oil and/or fat composition for cooking of [2], wherein the silicone oil has a kinematic viscosity at 25° C. of 800 to 5000 mm²/s.
[4] The oil and/or fat composition for cooking of any one of [1] to [3], wherein the oil and/or fat is liquid at 20° C.
[5] The oil and/or fat composition for cooking of any one of [1] to [4] , wherein the fat composition for cooking is used to reduce the oil and/or fat content remaining in a cooked material after cooking.
[6] A method for producing an oil and/or fat composition for cooking, comprising adding polyglycerin fatty acid esters to an oil and/or fat composition comprising an oil and/or fat,

wherein the fat in the fat composition consists of one of or a combination of two or more of animal or vegetable oils and/or fats, hydrogenated oils and/or fats thereof, oil and/or fat fractions thereof, and transesterified oils and/or fats thereof,

80% by mass or more of glycerides of the oil and/or fat are triglycerides,

the amount of the polyglycerin fatty acid esters in the resultant oil and/or fat composition for cooking is 0.02 to 0.09% by mass,

the polyglycerin fatty acid esters have an HLB value of 3.5 or lower, and

5 to 50% by mass of constituent fatty acids of the polyglycerin fatty acid esters are an unsaturated fatty acid(s) having 8 to 22 carbon atoms.

[7] The method for producing an oil and/or fat composition for cooking of [6] , further comprising adding 0.5 to 5 ppm of a silicone oil to the oil and/or fat composition for cooking,

wherein the content of the polyglycerin fatty acid esters added is 0.04 to 0.08% by mass in the oil and/or fat composition for cooking.

[8] A method for reducing the oil and/or fat content remaining in a cooked material after cooking, comprising adding polyglycerin fatty acid esters to an oil and/or fat composition comprising an oil and/or fat and a silicone oil,

wherein the oil and/or fat in the oil and/or fat composition consists of one of or a combination of two or more of animal or vegetable oils and/or fats, hydrogenated oils and/or fats thereof, oil and/or fat fractions thereof, and transesterified oils and/or fats thereof,

80% by mass or more of glycerides of the oil and/or fat are triglycerides,

the amount of the polyglycerin fatty acid esters in the resultant oil and/or fat composition for cooking is 0.02 to 0.09% by mass,

the polyglycerin fatty acid esters have an HLB value of 3.5 or lower, and

5 to 50% by mass of constituent fatty acids of the polyglycerin fatty acid esters are an unsaturated fatty acid(s) having 8 to 22 carbon atoms.

According to the oil and/or fat composition for cooking, the method for producing an oil and/or fat composition for cooking, and the method for reducing the oil and/or fat content remaining in a cooked material after cooking of the present invention, the oil and/or fat content remaining in a cooked material can be highly efficiently reduced, when the oil and/or fat composition comprising 0.02 to 0.09% by mass of the specific polyglycerin fatty acid esters is used for cooking.

In addition, it is also possible to provide an effect of reducing the oil and/or fat content remaining in a cooked material after cooking to an oil and/or fat for cooking by adding 0.02 to 0.09% by mass of the specific polyglycerin fatty acid esters to the oil and/or fat for cooking. Since the amount of the specific polyglycerin fatty acid esters blended is small, the production costs are low, and it is possible to impart a good taste similar to the original taste of the fat to a cooked material.

Because of these advantages, the oil and/or fat composition for cooking of the present invention can be preferably used as an oil and/or fat for preparing deep-fried foods, especially, for preparing TEMPURA, KARAAGE, and the like. The oil and/or fat composition for cooking of the present invention can be preferably used also for stir frying.

### DESCRIPTION OF EMBODIMENTS

An oil and/or fat composition for cooking of the present invention comprises 0.02 to 0.09% by mass of polyglycerin fatty acid esters. The polyglycerin fatty acid esters have an HLB value of 3.5 or lower, and 5 to 50% by mass of constituent fatty acids of the polyglycerin fatty acid esters are an unsaturated fatty acid(s) having 8 to 22 carbon atoms.

A method for reducing the oil and/or fat content in a deep-fried product such as TEMPURA may be (1) reduction of the amount of attached coating , which readily absorbs oil and/or fat, by reducing the thickness of the coating, (2) reduction of the amount of oil and/or fat absorbed by the coating portion, (3) reduction of the amount of oil and/or fat absorbed by the food ingredient, (4) promotion of oil and/or fat removal after deep-frying (draining the oil and/or fat after deep-frying), or the like. Since a large proportion of the oil and/or fat in a deep-fried product such as TEMPURA is contained in the coating portion rather than the ingredient for deep-frying (the food ingredient inside the coating), it can be said that (2) the reduction of the amount of oil absorbed by the coating portion is particularly effective in reducing the oil and/or fat content in a cooked product, among the above-described methods.

The inventors have conducted intensive study to produce an oil and/or fat composition which is less easily absorbed by a coating portion of a deep-fried product and which can be easily drained, and consequently found that the amount of oil and/or fat absorbed by an object being cooked during deep-frying can be reduced, when 0.02 to 0.09% by mass of specific polyglycerin fatty acid esters are added to an oil and/or fat. Based on this finding, the present invention has achieved an oil and/or fat composition for cooking to which a small amount of specific polyglycerin fatty acid esters are added and with which the amount of oil and/or fat absorbed by a cooked material can be reduced efficiently.

<Oil and/or Fat Composition For Cooking>

Hereinafter, each component of the oil and/or fat composition for cooking of the present invention is described in detail.

1. Oil and/or Fat

The oil and/or fat composition for cooking of the present invention comprises an ordinary oil and/or fat for cooking as a main component. As the ordinary oil and/or fat for cooking, one of or a combination of two or more of animal or vegetable oils and/or fats, hydrogenated oils and/or fats thereof, oil and/or fat fractions thereof, and transesterified oils and/or fats thereof generally used for cooking can be used. Examples of the animal or vegetable oil and/or fats include soybean oil, rapeseed oil, high oleic rapeseed oil, sunflower oil, high oleic sunflower oil, olive oil, safflower oil, high oleic safflower oil, corn oil, cottonseed oil, rice bran oil, beef tallow, butterfat, fish oil, coconut oil, palm oil, palm kernel oil, and the like. Since an oil and/or fat which is solid at room temperature has to be melted by heating for the use, an oil and/or fat which is liquid at 20° C. is preferable. Even a raw material oil and/or fat, which is solid at 20° C. by itself, can be preferably used, if the raw material oil and/or fat is used in combination with another raw material oil and/or fat and the resultant oil and/or fat is liquid as a whole. However, it is more preferable that all of the raw material oils and/or fats be liquid. Especially, rapeseed oil, a mixture of rapeseed oil and soybean oil, and the like can be preferably used, because it is advantageous that they are liquid oils with low melting points, but have good oxidation stability. In the oil and/or fat composition for cooking, 80% by mass or more of glycerides are triglycerides. The content of triglycerides is preferably 85% by mass or higher, more preferably 90% by mass or higher, and most preferably 95% by mass or higher. Vegetable oils and/or fats such as soybean oil, rapeseed oil, corn oil, and sunflower oil generally have triglyceride contents of 95% by mass or higher.

The above-described ordinary oil and/or fat for cooking preferably constitutes the balance of the oil and/or fat composition for cooking of the present invention, except for a silicone oil, polyglycerin fatty acid esters, and other optionally added additives.

### 2. Polyglycerin Fatty Acid Esters

Effects of the specific polyglycerin fatty acid esters in cooking a deep-fried product such as TEMPURA are as follows. For example, for cooking TEMPURA, a food ingredient and batter (a mixture of wheat flour for TEMPURA and water) are heated in oil and/or fat at high temperature (160 to 200° C.). When the batter comes in contact with the oil and/or fat at high temperature, water rapidly vaporizes and disappears at the contact surface with the oil and/or fat, and simultaneously the solid contents in the batter containing wheat flour as a main component are is baked and hardened. With the repetition of this phenomenon, the removal of water in the batter gradually proceeds, and a coating having a network structure in which the wheat flour is baked and hardened in a porous state is formed. An ordinary emulsifier exerts an influence on the tension at the gas-liquid or liquid-liquid interface, whereas the specific polyglycerin fatty acid esters change the tension at the interface between “oil (fat) and solid”, between “oil (fat) and water,” or between “oil (fat) and gas (water vapor)” during the formation of the coating to alter the properties (shape, components, and physical properties) of the coating.

Polyglycerin fatty acid esters which can be added to the oil and/or fat composition for cooking of the present invention have an HLB value of 3.5 or lower, and 5 to 50% by mass of constituent fatty acids of the polyglycerin fatty acid esters are an unsaturated fatty acid(s) having 8 to 22 carbon atoms. Preferably, 10 to 35% by mass of the constituent fatty acids are an unsaturated fatty acid(s) having 8 to 22 carbon atoms. As these emulsifier components, those commercially available as food additives can be used, as appropriate. For example, polyglycerin fatty acid esters used as a crystallization inhibitor can be used, and “THL-15” (manufactured by SAKAMOTO YAKUHIN KOGYO CO., LTD) or the like can be used.

The amount of the polyglycerin fatty acid esters blended is 0.02 to 0.09% by mass, preferably 0.03 to 0.09% by mass, more preferably 0.04 to 0.08% by mass, and most preferably 0.05 to 0.07% by mass relative to the oil and/or fat composition for cooking of the present invention. As described later, the polyglycerin fatty acid esters used in the present invention are characterized in that when the polyglycerin fatty acid esters are added to the oil and/or fat composition for cooking in an amount of 0.02 to 0.09% by mass, the polyglycerin fatty acid esters can minimize the amount of oil and/or fat absorbed by a cooked material.

The polyglycerin fatty acid esters have an HLB value of 3.5 or lower. A lower limit value of the HLB is preferably 0, and more preferably 1. An upper limit value of the HLB is preferably 3.3, and more preferably 3. The HLB value is most preferably 1 to 3.

Note that the HLB is an abbreviation of hydrophile-lipophile balance. The HLB serves as an index to find whether an emulsifier is hydrophilic or lipophilic, and takes a value between 0 to 20. A smaller HLB value indicates a higher lipophilicity. In the present invention, the HLB value is calculated by using the calculation method of the Atlas method. The calculation method of the Atlas method refers to a method in which the HLB value is calculated by using

HLB=20×(1−S/A),

where

S is the saponification value, and

A is the neutralization number of the fatty acids of the esters.

The constituent fatty acids of the polyglycerin fatty acid esters are such that an unsaturated fatty acid(s) having 8 to 22 carbon atoms accounts for 5 to 50% by mass of the constituent fatty acids of the polyglycerin fatty acid esters. More preferably, the unsaturated fatty acid(s) having 8 to 22 carbon atoms accounts for 20 to 30% by mass of the constituent fatty acids of the polyglycerin fatty acid esters.

As the unsaturated fatty acids having 8 to 22 carbon atoms and constituting the polyglycerin fatty acid esters, oleic acid, erucic acid, and the like can be used. The constituent fatty acids other than the unsaturated fatty acids are saturated fatty acids having 8 to 22 carbon atoms. Note that lauric acid, myristic acid, palmitic acid, stearic acid, behenic acid, and the like can be used as the saturated fatty acids.

### 3. Silicone Oil

The oil and/or fat composition for cooking of the present invention may comprise a silicone oil. As the silicone oil, one having a dimethyl polysiloxane structure and having a kinematic viscosity at 25° C. of 800 to 5000 mm²/s is used. The kinematic viscosity of the silicone oil particularly preferably 800 to 2000 mm²/s, and further preferably 900 to 1100 mm²/s. If the kinematic viscosity at 25° C. of the silicone oil is lower than 800 mm²/s, an effect of inhibiting the formation of bubbles in the oil and/or fat composition under heating is insufficient. Meanwhile, if the kinematic viscosity exceeds 5000 mm²/s, such a silicone oil is difficult to dissolve in the fat composition. As the silicone oil, one commercially available for food applications can be used. Note that the “kinematic viscosity” herein refers to a value measured according to JIS K 2283 (2000). The silicone oil may contain fine particles of silica in addition to the silicone oil.

The silicone oil content in the fat composition for cooking of the present invention is 0.5 to 5 ppm, more preferably 1 to 4 ppm, and further preferably 2 to 3 ppm (ratio by mass) in the fat composition for cooking. If the overall content of the silicone oil is less than 0.5 ppm, the obtained effect of inhibiting the formation of bubbles during cooking is insufficient. Meanwhile, if the overall content of the silicone oil exceeds 5 ppm, it is difficult to vaporize water in the oil and/or fat from the surface of the oil and/or fat, and the formation of bubbles may be promoted in some cases.

When the oil and/or fat composition for cooking of the present invention contains the silicone oil, the content of the above-described polyglycerin fatty acid esters is preferably 0.04 to 0.08% by mass, because this makes it possible to minimize the amount of oil and/or fat absorbed by a cooked material.

### 4. Other Components

Other components can be added to the oil and/or fat composition for cooking, unless an effect of the present invention is impaired. These components are, for example, components (such as food additives) used for ordinary oils and/or fats. Examples of these components include antioxidants, crystal modifiers, texture improvers, emulsifiers, and the like. These other components are preferably added after deodorization but before packaging.

Examples of the antioxidants include tocopherols, ascorbic acids, flavone derivatives, Kojic acid, gallic acid derivatives, catechins, esters thereof, fukiic acid, gossypol, sesamol, terpenes, and the like. Examples of coloring components include carotene, astaxanthin, and the like. Other emulsifiers which do not exert any influence on the effect of reducing the amount of oil absorbed are selected, as appropriate, from sucrose fatty acid esters, sorbitan fatty acid esters, polysorbates, propylene glycol fatty acid esters, polyglycerol polyricinoleate, diacylglycerol, waxes, sterol esters, phospholipids, and the like.

<Method for Producing Fat Composition for Cooking>

As in the case of ordinary oils and/or fats, the oil and/or fat used for the oil and/or fat composition for cooking according to the present invention can be produced by conducting the following refinement on a crude oil and/or fat extracted from seeds or fruits of a plant or from an animal ingredient used as a starting raw material. Specifically, the crude oil and/or fat is optionally subjected to a degumming step, a deacidification step, and a decolorization step in this order, optionally subjected further to a dewaxing step, and then subjected to a deodorization step. The above-described degumming step, deacidification step, and dewaxing step are selected, as appropriate, according to the quality of the crude oil and/or fat which may vary depending on the raw material for oil and/or fat before the extraction.

The production method of the present invention comprises a step of adding polyglycerin fatty acid esters to the oil and/or fat with the resultant content of the polyglycerin fatty acid esters in the oil and/or fat composition being 0.02 to 0.09% by mass, in addition to the above-described oil and/or fat refinement step. The polyglycerin fatty acid esters are the above-described polyglycerin fatty acid esters which have an HLB value of 3.5 or lower and in which an unsaturated fatty acid(s) having 8 to 22 carbon atoms accounts for 5 to 50% by mass of the constituent fatty acids of the polyglycerin fatty acid esters. In addition, it is also possible to conduct a step of adding a silicone oil and polyglycerin fatty acid esters to the fat composition, with the resultant content of the silicone oil being 0.5 to 5 ppm in the oil and/or fat composition, and with the resultant content of the polyglycerin fatty acid esters being 0.04 to 0.08% by mass in the oil and/or fat composition.

The polyglycerin fatty acid esters and/or the silicone oil are preferably blended in such a manner that, after the oil and/or fat subjected to the refinement step is heated, the polyglycerin fatty acid esters and/or the silicone oil are added to and dissolved in the oil and/or fat. Note that, the production method may optionally comprise steps of adding other additives. The steps of adding other additives are desirably carried out after the oil and/or fat refinement step, and conditions such as the oil and/or fat temperature during the addition are desirably changed, as appropriate, according to the types and purposes of the additives.

<Method for Reducing Oil and Fat Content Remaining in Cooked Material after Cooking>

A method for reducing the oil and/or fat content remaining in a cooked material after cooking of the present invention comprises an operation of adding polyglycerin fatty acid esters to an oil and/or fat composition comprising a silicone oil with the resultant content of the polyglycerin fatty acid esters being 0.04 to 0. 08% by mass. The polyglycerin fatty acid esters have an HLB value of 3.5 or lower, and 5 to 50% by mass of constituent fatty acids of the polyglycerin fatty acid esters are an unsaturated fatty acid(s) having 8 to 22 carbon atoms. As the fat composition containing a silicone oil, either an oil and/or fat composition not having been used for cooking or an oil and/or fat composition having been used for cooking can be used. In deep-frying or the like, the polyglycerin fatty acid esters in the oil and/or fat composition may be consumed during the cooking, and hence it is preferable to replenish the polyglycerin fatty acid esters to keep 0.04 to 0.08% by mass.

The method for producing a oil and/or fat composition for cooking of the present invention makes it possible to obtain an oil and/or fat composition for cooking which is capable of highly efficiently reducing the oil and/or fat content remaining in a cooked material, when an oil and/or fat composition containing a silicone oil is used for cooking.

### EXAMPLES

Hereinafter, the present invention will be described specifically based on Examples; however, the present invention is not limited to these examples.

### <Test 1: TEMPERA Experiment>

Oil and/or fat compositions for cooking containing a silicone oil and/or a polyglycerin fatty acid ester(s) were prepared, and TEMPURA was actually prepared by using these oil and/or fat compositions to test the effect of reducing the oil and/or content in cooked materials.

### 1. Sample Preparation

Oil and/or fat compositions for cooking (deep-frying oils) of Experimental Example 1 were each obtained as follows. Specifically, polyglycerin fatty acid esters A “THL-15” (manufactured by SAKAMOTO YAKUHIN KOGYO CO., LTD: the HLB value was 3.5 or lower, unsaturated fatty acids having 8 to 22 carbon atoms accounted for 5 to 50% by mass of the constituent fatty acids of the polyglycerin fatty acid esters) in the corresponding amount shown in Table 1 were mixed with a base oil A not containing silicone oil and being obtained by mixing a refined rapeseed oil “Nisshin Canola Oil” (manufactured by manufactured by The Nisshin OilliO Group, Ltd.) and a refined soybean oil “Nisshin Soybean Salad Oil (S)” (manufactured by The Nisshin OilliO Group, Ltd.) with each other at a ratio of 5:5. Further, a base oil B was prepared by mixing 3 ppm of a silicone oil “KF-96 1000CS” (manufactured by Shin-Etsu Chemical Co., Ltd., the kinematic viscosity at 25° C. was 1000 mm²/s) with the base oil A. Then, fat compositions for cooking (fats for deep-frying) of Experimental Example 2 were each prepared by mixing polyglycerin fatty acid esters “THL-15” (manufactured by SAKAMOTO YAKUHIN KOGYO CO., LTD) in the corresponding amount with the base oil B. In addition, oil and/or fat compositions for cooking (fats for deep-frying) of Comparative Example 3 were prepared by mixing a polyglycerin fatty acid ester B “SY Glyster 0E-750” (manufactured by SAKAMOTO YAKUHIN KOGYO CO., LTD: the HLB was 3.7, polyglycerin octa-erucate) with the base oil A. The polyglycerin fatty acid esters and the silicone oil were mixed with the fat in such a manner that 1000 g of the oil and/or fat placed in an iron pan was heated to 180° C., and then polyglycerin fatty acid esters and the silicone oil were added to and dissolved in the oil and/or fat.

Sweet potato was cut into cylindrical pieces with a thickness of 5 mm and a diameter of 3.4 cm, and used as a deep-frying ingredient. Batter was prepared by mixing 38 g of wheat flour for TEMPURA “Showa Tempurako” (manufactured by Showa Sangyo Co., Ltd.) with 62 g of ice water. The batter was attached to the sweet potato by immersing the sweet potato in the liquid batter.

Five pieces of the sweet potato to which the batter was attached were introduced into each of the oils and/or fats for deep-frying heated to 180° C. in an iron pan, and cooked for 3 minutes. Here, 1.5 minutes after the start of the cooking, the pieces of sweet potato in each oil and/or fat for deep-frying were overturned once. After being cooked for 3 minutes, the deep-fried products were transferred onto a wire rack and allowed to stand to drain oil and/or fat. Five minutes later, the deep-fried products were collected and used as measurement samples.

Ten samples of the deep-fried products were prepared for each of the oils and/or fats for deep-frying.

2. Oil and/or Fat Content Measurement

After the weights of the above-described samples (deep-fried products) were measured, the samples were dried under reduced pressure to remove water.

Each of the dried samples was immersed in 30 mL of hexane to dissolve the oil and/or fat contained in the sample into a hexane fraction (oil and/or fat extraction) . The hexane fraction was collected, and the hexane was removed. Then, the weight of the remaining oil and/or fat was measured. An average value of the 10 samples was employed as the oil and/or fat content. A value obtained by dividing the oil and/or fat content by the average weight of the samples before drying was employed as the oil and/or fat content ratio. Table 1 shows the oil and/or fat content ratio (%) of the samples obtained by using each of the oils and/or fats for deep-frying.

TABLE 1

| | | Amount of polyglycerin fatty | | | | |
|---|---|---|---|---|---|---|
| | | acid ester(s) added | | | | |
| | | (% by mass) | | | | |
| | | 0 | 0.04 | 0.06 | 0.08 | 0.10 |
| Experimental | Polyglycerin fatty | 21.1 | 20.0 | 19.6 | 20.1 | 20.7 |
| Example 1 | acid esters A | (—) | (−5%) | (−7%) | (−5%) | (−2%) |
| | (silicone oil-free) | | | | | |
| Experimental | Polyglycerin fatty | 21.0 | 20.4 | 19.9 | 20.3 | 21.1 |
| Example 2 | acid esters A | (—) | (−3%) | (−5%) | (−3%) | (0%) |
| | (containing | | | | | |
| | silicone oil) | | | | | |
| Comparative | Polyglycerin fatty | 21.1 | — | 21.3 | 21.0 | 21.1 |
| Example 3 | acid ester B | (—) | | (1%) | (0%) | (0%) |
| | (silicone oil-free) | | | | | |

*Each value in ( ) is a ratio of increase or decrease in comparison with the corresponding case where the polyglycerin fatty acid ester(s) was not added.

As shown in Table 1, it was found that, in the case of the oil and/or fat compositions for cooking (Experimental Example 1) to which the polyglycerin fatty acid esters A were added, the oil and/or fat content ratio in the deep-fried products was reduced when the amount of the polyglycerin fatty acid esters A added was in a specific range. Specifically, when the blended amount of the polyglycerin fatty acid esters A, which had an HLB value of 3.5 or lower and in which 5 to 50% by mass of constituent fatty acids were unsaturated fatty acids having 8 to 22 carbon atoms, was 0% or 0.10%, no effect was observed. In contrast, when the blended amount was 0.04 to 0.08% by mass, a remarkable reducing effect was observed, and it is expectable that the oil and/or fat content ratio can be reduced when the blended amount is in a range from 0.02 to 0.09% by mass.

### 2. Taste and Texture Evaluation

The above-described experiments for preparing samples (Experimental Examples 1 and 2) of Test 1 were repeated again, and the taste of each sample was compared with that of the sample obtained by using the corresponding base oil and/or fat. There was no difference in taste between the samples, and all the samples had good taste.

The oil and/or fat composition for cooking of the present invention can be used in the field of food manufacturing, especially, as an oil and/or fat for deep-frying used for producing deep-fried products . In addition, the oil and/or fat composition for cooking of the present invention can also be used for producing any other foods for which an oil and/or fat for cooking is necessary.

What is claimed is:

1. An oil and/or fat composition for cooking, comprising an oil and/or fat and 0.02 to 0.09% by mass of polyglycerin fatty acid esters,
wherein the oil and/or fat in the oil and/or fat composition for cooking consists of one of or a combination of two or more of animal or vegetable oil and/or fats, hydrogenated oils and/or oils thereof, oil and/or fat fractions thereof, and transesterified oils and/or fats thereof,
80% by mass or more of glycerides of the oil and/or fat are triglycerides,
the polyglycerin fatty acid esters have an HLB value of 3.5 or lower, and
5 to 50% by mass of constituent fatty acids of the polyglycerin fatty acid esters are an unsaturated fatty acid(s) having 8 to 22 carbon atoms.

2. The oil and/or fat composition for cooking according to claim 1, wherein the content of the polyglycerin fatty acid esters is 0.04 to 0.08% by mass, and 0.5 to 5 ppm of a silicone oil is further contained.

3. The oil and/or fat composition for cooking according to claim 2, wherein the silicone oil has a kinematic viscosity at 25° C. of 800 to 5000 mm²/s.

4. The oil and/or fat composition for cooking according to claim 1, wherein the oil and/or fat is liquid at 20° C.

5. The oil and/or fat composition for cooking according to claim 1, wherein the oil and/or fat composition for cooking is used to reduce the oil and/or fat content remaining in a cooked material after cooking.

6. A method for producing an oil and/or fat composition for cooking, comprising adding polyglycerin fatty acid esters to an oil and/or fat composition comprising an oil and/or fat,
wherein the oil and/or fat in the oil and/or fat composition consists of one of or a combination of two or more of animal or vegetable oils and/or fats, hydrogenated oils and/or fats thereof, oil and/or fat fractions thereof, and transesterified oils and fats thereof,
80% by mass or more of glycerides of the oil and/or fat are triglycerides,
the amount of the polyglycerin fatty acid esters in the resultant oil and/or fat composition for cooking is 0.02 to 0.09% by mass,
the polyglycerin fatty acid esters have an HLB value of 3.5 or lower, and
5 to 50% by mass of constituent fatty acids of the polyglycerin fatty acid esters are an unsaturated fatty acid(s) having 8 to 22 carbon atoms.

7. The method for producing an oil and/or fat composition for cooking according to claim 6, further comprising adding 0.5 to 5 ppm of a silicone oil to the fat composition for cooking, wherein the content of the polyglycerin fatty acid esters added is 0.04 to 0.08% by mass in the oil and/or fat composition for cooking.

8. A method for reducing the oil and/or fat content remaining in a cooked material after cooking, comprising adding polyglycerin fatty acid esters to a fat composition comprising an oil and/or fat and a silicone oil, wherein the oil and/or fat in the fat composition consists of one of or a combination of two or more of animal or vegetable oils and/or fats, hydrogenated oils and/or fats thereof, oil and/or fat fractions thereof, and transesterified oils and/or fats thereof,
80% by mass or more of glycerides of the oil and/or fat are triglycerides,
the amount of the polyglycerin fatty acid esters in the resultant oil and/or fat composition for cooking is 0.02 to 0.09% by mass,
the polyglycerin fatty acid esters have an HLB value of 3.5 or lower, and
5 to 50% by mass of constituent fatty acids of the polyglycerin fatty acid esters are an unsaturated fatty acid(s) having 8 to 22 carbon atoms.
